(19) United States
(12) Patent Application Publication
(10) Pub. No.: US 2026/0298698 A1
(43) Pub. Date: Oct. 1, 2026

(54) SYNTHESIZING FAULT DATA IN A MECHANICAL SYSTEM

(71) Applicant: TDK U.S.A. Corporation, Uniondale, NY (US)

(72) Inventors: Milad POOLADSANJ, Irvine, CA (US); Juan S Mejia SANTAMARIA, San Jose, CA (US); Darby Michael LOSEY, Pittsburgh, PA (US); Vishal VIJAYAKUMAR, Fremont, CA (US)

(73) Assignee: TDK U.S.A. Corporation, Uniondale, NY (US)

(21) Appl. No.: 19/559,668

(22) Filed: Mar. 6, 2026

Related U.S. Application Data
(60) Provisional application No. 63/780,115, filed on Mar. 28, 2025.

(51) Int. Cl. G01H 1/00; G01M 13/045

(52) U.S. Cl. CPC G01H 1/003; G01M 13/045

(57) ABSTRACT

In a method for synthesizing fault data for a mechanical system, vibration data is collected from a mechanical system during operation, wherein the vibration data is collected at at least one sensor coupled to the mechanical system. Residual vibration data is synthesized using a mathematical model representing residual forces induced by a particular fault of the mechanical system. The vibration data is combined with the synthesized residual vibration data to generate fault vibration data for the particular fault, wherein the fault vibration data simulates data associated with an unobserved event.

### RELATED APPLICATION

This application claims priority to and the benefit of co-pending U.S. Provisional Patent Application 63/780,115, filed on Mar. 28, 2025, entitled “SYSTEM AND METHOD FOR FAULT DATA SYNTHESIS USING OPERATIONAL DATA AND DYNAMICAL MODELING,” by Pooladsanj et al., having Attorney Docket No. IVS-1163-PR, and assigned to the assignee of the present application, which is incorporated herein by reference in its entirety.

### BACKGROUND

Mechanical systems, such as rotor-bearing systems, are critical components in numerous industrial applications, including aerospace, automotive, and energy production. Ensuring their reliability and performance is crucial, as faults in these systems can lead to catastrophic failures and costly downtime. Fault diagnosis and prognosis typically rely on vibration data collected from faulty systems. However, acquiring such data is challenging due to the cost, complexity, and controlled conditions required to replicate specific faults in a physical system.

### BRIEF DESCRIPTION OF DRAWINGS

The accompanying drawings, which are incorporated in and form a part of the Description of Embodiments, illustrate various non-limiting and non-exhaustive embodiments of the subject matter and, together with the Description of Embodiments, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 is a block diagram illustrating an example rotor-bearing mechanical system, upon which embodiments described herein may be implemented.

FIG. 2 is a block diagram illustrating an example system for synthesizing fault data in a mechanical system, in accordance with embodiments.

FIG. 3 is a block diagram illustrating an example computational module, in accordance with embodiments.

FIG. 4 is a block diagram illustrating an example fault detection module, in accordance with embodiments.

FIG. 5 is a flow diagram illustrating an example method synthesizing fault data for a mechanical system, according to embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “collecting,” “synthesizing,” “training,” determining,” “combining,” “deploying,” “generating,” “deriving,” “analyzing,” “monitoring,” “processing,” “using,” “performing,” “outputting,” or the like, refer to the actions and processes of an electronic device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example ultrasonic sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example rotor-bearing mechanical system upon which embodiments described herein can be implemented. An example system for synthesizing fault data is then described. An example computational system for synthesizing fault data is then described. An example fault detection system for performing fault detection based on the synthesized fault data is then described. Example operations of synthesizing fault data are then described.

Mechanical systems, such as rotor-bearing systems, are critical components in numerous industrial applications, including aerospace, automotive, and energy production. Ensuring their reliability and performance is crucial, as faults in these systems can lead to catastrophic failures and costly downtime. Fault diagnosis and prognosis typically relies on vibration data collected from faulty systems. However, acquiring such data is challenging due to the cost, complexity, and controlled conditions required to replicate specific faults in a physical system. For instance, fault events are relatively uncommon during system operation, and collection of sensor data of such fault events is thus also infrequent.

Example embodiments described herein provide for methods and systems that can accurately and efficiently synthesize fault data using available healthy system data and mathematical modeling of the system. The described embodiments provide a method for synthesizing fault data in mechanical systems by combining mathematical modeling of fault-induced forces with the mechanical system's dynamics. The embodiments use derived fault-specific residual force expressions and the mathematical model of the system to calculate residual vibrations, which are then added to healthy system data to generate realistic faulty system data. The described embodiments eliminate the need for experimental fault replication, integrate physical and dynamic modeling, and is adaptable to various fault types and systems, offering a cost-effective and precise alternative to traditional fault data generation methods. The fault data that is synthesized is realistic and reflective of actual system behavior, which is difficult to achieve with purely synthetic or simulated data. The synthesized fault data can be used to train advanced machine learning algorithms for fault detection and diagnosis, improving accuracy and robustness in real-world applications.

Embodiments described herein provide a method for synthesizing fault data for a mechanical system. Vibration data is collected from a mechanical system during operation, wherein the vibration data is collected at at least one sensor coupled to the mechanical system. In some embodiments, the mechanical system is modeled as linear time invariant behavior. In some embodiments, the mechanical system is a rotational system. In some embodiments, the mechanical system comprises a rotor bearing. In some embodiments, the collected vibration data is time series sensor data.

Residual vibration data is synthesized using a mathematical model representing residual forces induced by a particular fault of the mechanical system. In some embodiments, the mathematical model representing the residual forces induced by the particular fault of the mechanical system is derived. In some embodiments, a transfer function from the residual forces to the residual vibration data is calculated using a Linear Time Invariant (LTI) model of the mechanical system. In some embodiments, the mathematical model is a dynamical model comprising a plurality of tunable parameters, wherein the plurality of tunable parameters are used to model the particular fault.

The vibration data is combined with the synthesized residual vibration data to generate fault vibration data for the particular fault, wherein the fault vibration data simulates data associated with an unobserved event. In some embodiments, a proxy machine learning model is trained using the fault vibration data to perform fault detection on the mechanical system to identify the particular fault during operation of the mechanical system. In some embodiments, the proxy machine learning model is deployed to perform the fault detection on the mechanical system on the collected vibration data.

Some embodiments described herein provide a system for synthesizing fault data in a mechanical system, the system including a sensor, a data acquisition module, and a computational module. The sensor is coupled to the mechanical system, where the sensor for sensing vibration data from the mechanical system during operation. The data acquisition module of the system is for collecting the vibration data from the mechanical system during operation. In some embodiments, the mechanical system is modeled as linear time invariant behavior. In some embodiments, the mechanical system is a rotational system. In some embodiments, the mechanical system comprises a rotor bearing. In some embodiments, the collected vibration data is time series sensor data.

The computational module of the system is configured to synthesize residual vibration data using a mathematical model representing residual forces induced by a particular fault of the mechanical system. In some embodiments, the computational module is further configured to derive the mathematical model representing the residual forces induced by the particular fault of the mechanical system. In some embodiments, the computational module is further configured to use an LTI model of the mechanical system to calculate a transfer function from the residual forces to the residual vibration data. In some embodiments, the mathematical model is a dynamical model comprising a plurality of tunable parameters, wherein the plurality of tunable parameters are used to model the particular fault.

The computational module is also configured to combine the vibration data with the synthesized residual vibration data to generate fault vibration data for the particular fault, wherein the fault vibration data simulates data associated with an unobserved event. In some embodiments, the computational module is further configured to train a proxy machine learning model using the fault vibration data to perform fault detection on the mechanical system to identify the particular fault during operation of the mechanical system. In some embodiments, the system also includes a fault detection module comprising the proxy machine learning model to perform the fault detection on the mechanical system on the collected vibration data.

The embodiments described herein greatly extend beyond conventional methods of synthesizing data. The described embodiments provide methods for synthesizing fault data by utilizing readily available healthy system data combined with mathematical and dynamic modeling, thereby eliminating the need for costly and time-intensive physical testing, and providing for safer, more scalable, and cost-effective fault data synthesis. The described embodiments also derive mathematical expressions for residual forces tailored to each specific fault type, resulting in more precise and realistic data, and provides adaptable and flexible methods for synthesis of fault data for various mechanical systems and fault conditions.

### Example Systems for Synthesizing Fault Data for a Mechanical System

Example embodiments described herein provide methods and systems synthesizing fault data for a mechanical system. Vibration data is collected from a mechanical system during operation, wherein the vibration data is collected at at least one sensor coupled to the mechanical system. Residual vibration data is synthesized using a mathematical model representing residual forces induced by a particular fault of the mechanical system. The vibration data is combined with the synthesized residual vibration data to generate fault vibration data for the particular fault, wherein the fault vibration data simulates data associated with an unobserved event.

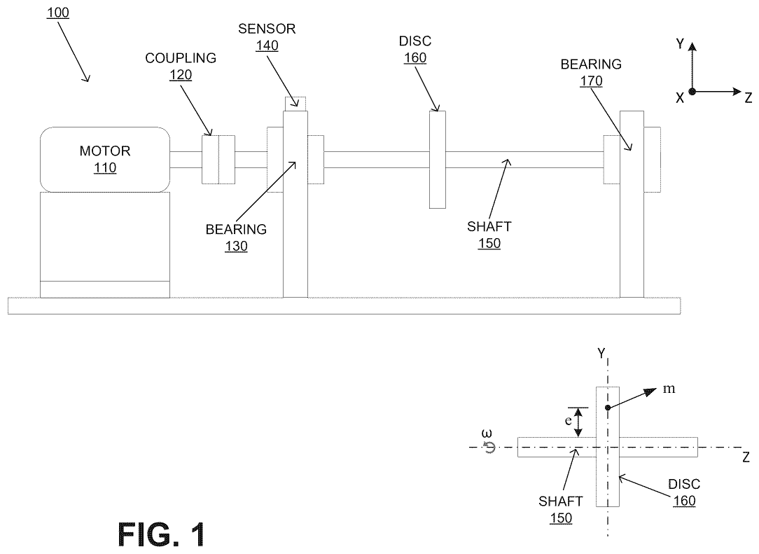

FIG. 1 is a block diagram illustrating an example rotor-bearing mechanical system 100, upon which embodiments described herein may be implemented. Rotor-bearing mechanical system 100 includes motor 110 coupled to shaft 150 via coupling 120. Shaft 150 is coupled to disc 160 and is rotationally supported at bearing 130 and 170. Sensor 140 is coupled to bearing 130. During operation, as motor 110 rotates shaft 150, vibration data is collected at sensor 140. In accordance with some embodiments, the vibration data is used as an input component in generating simulated or synthesized residual fault vibration data. In accordance with other embodiments, the vibration data is received at a machine learning model (e.g., a proxy machine learning model) for performing fault detection on rotor-bearing mechanical system 100.

Rotor-bearing mechanical system 100 is an example of a mechanical system for which vibration data can be collected for the generation of synthesized residual fault vibration data and/or for performing fault detection at a machine learning model, in accordance with some embodiments. Other examples of mechanical systems on which embodiments described herein can be implemented include motors, pumps, rotational systems, linear motors, cars, etc. It should be appreciated that embodiments described herein can be implemented using any type of rotating mechanical system that generates vibration data and any mechanical system that is capable of being modeled according to a linear time invariant (LTI) model.

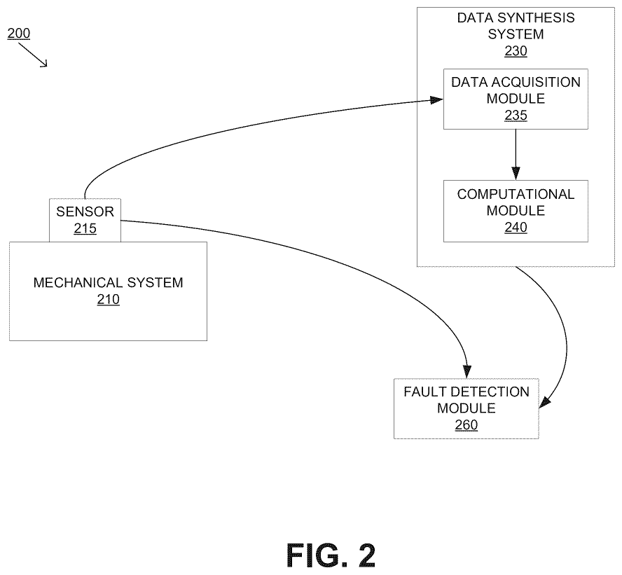

FIG. 2 is a block diagram illustrating an example system 200 for synthesizing fault data in a mechanical system, in accordance with embodiments. System 200 includes mechanical system 210 coupled to sensor 215 and data synthesis system 230. In some embodiments, system 200 also includes fault detection module 260. It should be appreciated that data synthesis system 230 and fault detection module 260 can be implemented as hardware, software, or any combination thereof. It should also be appreciated that data synthesis system 230 and fault detection module 260 may be separate components, may be comprised within a single component, or may be comprised in various combinations of multiple components, in accordance with some embodiments.

Mechanical system 210 is a mechanical system that generates vibration data, such as rotor-bearing mechanical system 100 of FIG. 1. It should be appreciated that mechanical system 210 can include any type of rotating mechanical system that generates vibration data and any mechanical system that is capable of being modeled according to an LTI model. In some embodiments, the mechanical system is a rotational system. In some embodiments, the mechanical system comprises a rotor bearing.

Sensor 215 is coupled to mechanical system 210, and is capable of sensing vibrations from mechanical system 210, also referred to herein as vibration data. In some embodiments, sensor 215 collects vibration data from a healthy mechanical system 210, where the collected vibration data is healthy system data. As used herein, a “healthy” mechanical system refers to a mechanical system that is operating under normal operating conditions and “healthy system data” is data that reflects the dynamic behavior of a healthy mechanical system under normal operating conditions. In some embodiments, the collected vibration data is time series sensor data.

Sensor 215 includes at least one motion sensor, including without limitation: a gyroscope, an accelerometer, a magnetometer, and/or other motion sensors such as a pressure sensor and/or an ultrasonic sensor. It should be appreciated that sensor 215 can be any type of sensor capable of sensing vibrations and generating vibration data. In some embodiments, sensor 215 is comprised within a sensor processing unit (SPU). In various embodiments, sensor 215 is communicatively coupled with data synthesis system 230 via a wired or wireless interface, or other well-known means. In some embodiments, sensor 215 is communicatively coupled with fault detection module 260 via a wired or wireless interface, or other well-known means.

Data synthesis system 230 is configured to receive vibration data from sensor 215 and synthesize residual vibration data using a mathematical model representing residual forces induced by a particular fault of mechanical system 210. Data synthesis system 230 combines the received vibration data with the synthesized residual vibration data to generate synthetic fault vibration data for the particular fault, where the fault vibration data simulates data associated with an unobserved event.

In some embodiments, data synthesis system 230 includes data acquisition module 235 for receiving the vibration data from sensor 215 and computational module 240. The vibration data is collected from a healthy mechanical system 210, and is gathered as baseline input representing the dynamic behavior of mechanical system 210 under normal operating conditions.

Computational module 240 is configured to synthesize residual vibration data using a mathematical model representing residual forces induced by a particular fault of the mechanical system. In some embodiments, computational module 240 is configured to derive the mathematical model representing the residual forces induced by the particular fault of the mechanical system. In some embodiments, computational module 240 is configured to use an LTI model of the mechanical system to calculate a transfer function from the residual forces to the residual vibration data. In some embodiments, the mathematical model is a dynamical model including a plurality of tunable parameters, wherein the plurality of tunable parameters are used to model the particular fault.

Computational module 240 is also configured to combine the vibration data with the synthesized residual vibration data to generate fault vibration data for the particular fault, wherein the fault vibration data simulates data associated with an unobserved event. The synthesized residual vibration data is added to vibration data received from sensor 215 to generate the fault vibration data for the faulty system experiencing a particular fault. The fault vibration data can be used for fault diagnosis, system analysis, or predictive maintenance applications.

In some embodiments, computational module 240 is configured to train a machine learning model (e.g., a proxy machine learning model) using the fault vibration data to perform fault detection on the mechanical system to identify the particular fault during operation of mechanical system 210. In some embodiments, mechanical system 210 also includes fault detection module 260 including the proxy machine learning model to perform the fault detection on mechanical system 210 on collected vibration data. As utilized herein, a “proxy” machine learning model refers to a machine learning model trained on synthetic data (e.g., the fault vibration data) in lieu of a machine learning model trained on actual fault data.

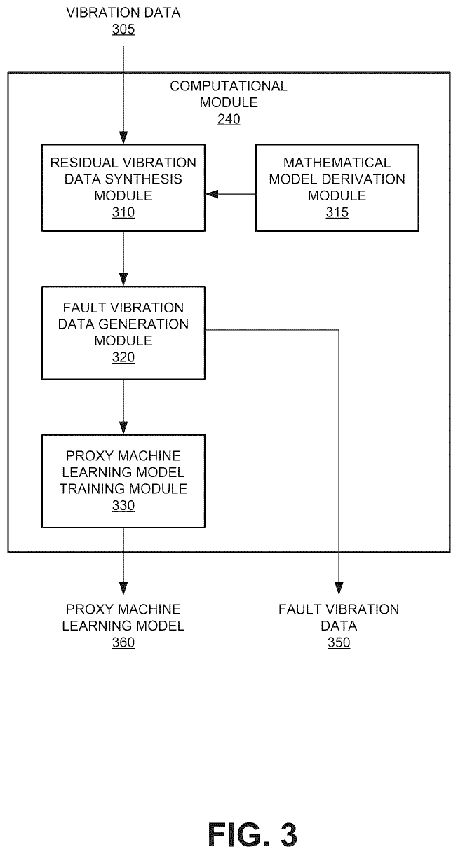

FIG. 3 is a block diagram illustrating an example computational module 240, in accordance with embodiments. Computational module 240 includes residual vibration data synthesis module 310 and fault vibration data generation module 320. In some embodiments, computational module 240 includes mathematical model derivation module 315. In some embodiments, computational module 240 includes proxy machine learning model training module 330.

Residual vibration data synthesis module 310 receives vibration data 305. It should be appreciated that vibration data 305 can be received from a sensor (e.g., sensor 215) or from data acquisition module 235. For a mechanical system operating under normal operating conditions, vibration data 305 is collected, with vibration data being based on forces being applied to the mechanical system. A transfer function transforms the forces into vibration, such that different forces can be mapped into vibrations using the transfer function. Where there is a fault in the mechanical system, residual forces are introduced on top of the normal forces. These residual forces can be transformed to vibrations using the same transfer function. To synthesize residual vibration data, the measured vibration data is added to the residual vibration data created by the residual forces. In this way, fault vibration data 350 for different types of faults can be generated using different residual vibration data.

Residual vibration data synthesis module 310 is configured to synthesize residual vibration data using a mathematical model representing residual forces induced by a particular fault of the mechanical system. In some embodiments, mathematical model derivation module 315 is configured to derive the mathematical model representing the residual forces induced by the particular fault of the mechanical system. In some embodiments, mathematical model derivation module 315 uses an LTI model of the mechanical system to calculate a transfer function from the residual forces to the residual vibration data. In some embodiments, the mathematical model is a dynamical model including a plurality of tunable parameters, wherein the plurality of tunable parameters are used to model the particular fault. It should be appreciated that residual vibration data synthesis module 310 can generate multiple instances of residual vibration data, each associated with a different fault.

Fault vibration data generation module 320 is configured to combine vibration data 305 with the synthesized residual vibration data generated at residual vibration data synthesis module 310 to generate fault vibration data 350 for the particular fault, wherein the fault vibration data simulates data associated with an unobserved event. Fault vibration data 350 can be used for fault diagnosis, system analysis, or predictive maintenance applications. In some embodiments, fault vibration data 350 is verified against any available experimental data (if applicable) or benchmarked through simulations to ensure accuracy. It should be appreciated that fault vibration data generation module 320 can generate multiple instances of fault vibration data 350 by combining vibration data 305 with different instances of residual vibration data, each associated with a different fault.

In some embodiments, proxy machine learning model training module 330 is configured to train proxy machine learning model 360 using fault vibration data 350 to perform fault detection on mechanical system 210 to identify the particular fault during operation of mechanical system 210. Proxy machine learning model 360 can be deployed (e.g., to receive sensor data from mechanical system 210) to perform fault detection on mechanical system 210. The described embodiments provide for meaningful training of proxy machine learning model 360 by generating fault vibration data 350 based on healthy system data and fault specific modeling for synthesizing a sufficient quantity of fault vibration data 350. It should be appreciated that proxy machine learning model training module 330 can train any number of proxy machine learning models 360, with each being trained to identify a particular fault.

With reference to FIG. 2, in some embodiments, mechanical system 210 also includes fault detection module 260 including a proxy machine learning model to perform the fault detection on mechanical system 210 on collected vibration data.

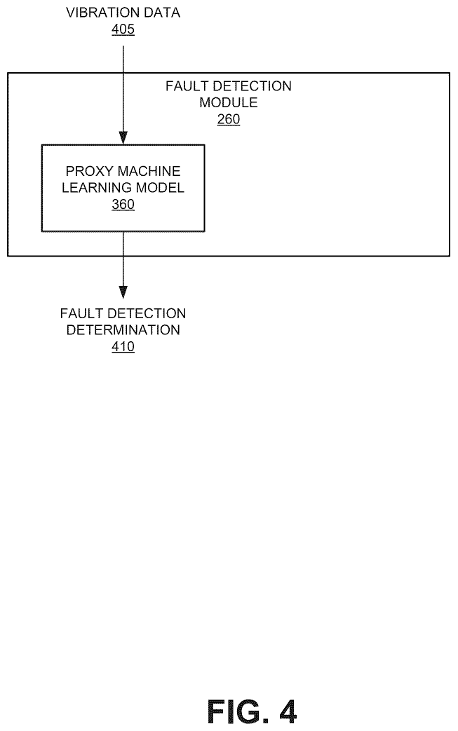

FIG. 4 is a block diagram illustrating example fault detection module 260, in accordance with embodiments. Fault detection module 260 includes proxy machine learning model 360, which is trained to identify a particular fault and is deployed to perform fault detection on mechanical system 210. It should be appreciated that fault detection module 260 can include any number of proxy machine learning models 360, with each being trained to identify a particular fault.

Proxy machine learning model 360 receives vibration data 405. It should be appreciated that vibration data 405 can be received from a sensor (e.g., sensor 215) or from data acquisition module 235. It should be appreciated that vibration data 405 can be used to generate additional fault vibration data, or can be received directly from a sensor for performing fault detection for a mechanical system. Proxy machine learning model 360 performs fault detection and diagnosis on vibration data 405, and generates fault detection determination 410 (e.g., the mechanical system is healthy and operating under normal conditions or the mechanical system is experiencing a fault event.

### Example Methods of Operation

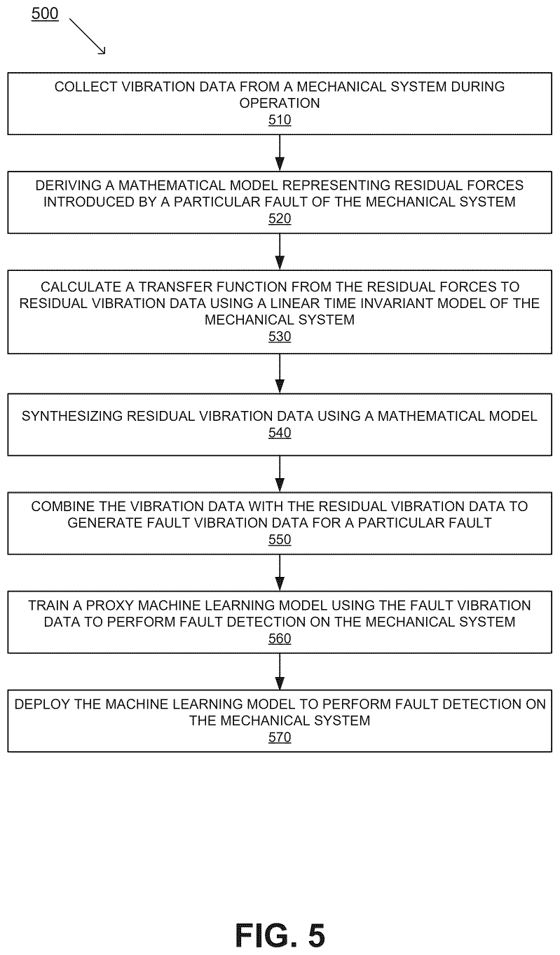

The following discussion sets forth in detail the operation of some example methods of operation of embodiments. With reference to FIG. 5, flow diagram 500 illustrates example procedures used by various embodiments. The flow diagram includes some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments. The computer-readable and computer-executable instructions, which reside on tangible computer readable storage media, are used to control, or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited for performing various other procedures or variations of the procedures recited in the flow diagram. Likewise, in some embodiments, the procedures in the flow diagram may be performed in an order different than presented and/or not all the procedures described in the flow diagram may be performed. It is further appreciated that procedures described in the flow diagrams may be implemented in hardware, or a combination of hardware with firmware and/or software provided by a computer system.

FIG. 5 is a flow diagram 500 illustrating an example method synthesizing fault data for a mechanical system, according to embodiments. At procedure 510 of flow diagram 500, vibration data is collected from a mechanical system during operation, wherein the vibration data is collected at at least one sensor coupled to the mechanical system. In some embodiments, the mechanical system is modeled as linear time invariant behavior. In some embodiments, the mechanical system is a rotational system. In some embodiments, the mechanical system comprises a rotor bearing. In some embodiments, the collected vibration data is time series sensor data.

In some embodiments, as shown at procedure 520, the mathematical model representing the residual forces induced by the particular fault of the mechanical system is derived. In some embodiments, as shown at procedure 530, a transfer function from the residual forces to the residual vibration data is calculated using a Linear Time Invariant (LTI) model of the mechanical system.

At procedure 540, residual vibration data is synthesized using a mathematical model representing residual forces induced by a particular fault of the mechanical system. In some embodiments, the mathematical model is a dynamical model comprising a plurality of tunable parameters, wherein the plurality of tunable parameters are used to model the particular fault.

At procedure 550, the vibration data is combined with the synthesized residual vibration data to generate fault vibration data for the particular fault, wherein the fault vibration data simulates data associated with an unobserved event. In some embodiments, as shown at procedure 560, a proxy machine learning model is trained using the fault vibration data to perform fault detection on the mechanical system to identify the particular fault during operation of the mechanical system. In some embodiments, as shown at procedure 570, the proxy machine learning model is deployed to perform the fault detection on the mechanical system on the collected vibration data.

The following is an example implementation of the described synthesis of fault data in a mechanical system. In the described example, the described method for synthesizing fault data is instantiated for an imbalance fault in the rotor-bearing mechanical system of FIG. 1.

With reference to FIG. 1, vibration data is collected from system 100 at sensor 140 during normal operating conditions (e.g., while system 100 is healthy). Sensor 140 (e.g., an accelerometer sensor) mounted at bearing 130 measures translational vibration of the shaft/disc assembly along the X-Y-Z axes. The measured healthy vibration acceleration is denoted by qu (t). For instance, this signal qH (t) is collected in procedure 510 of flow diagram 500. An imbalance fault on disc 160 is due to an object with mass m and eccentricity e from the centerline of shaft 150, as illustrated in FIG. 1.

The residual forces to an imbalance fault are modeled. An imbalance fault is modeled as a small mass m attached at an eccentricity e from the shaft centerline and rotating with angular speed w. In the rotating frame, the mass generates a centrifugal force of magnitude meω² rotating at the same angular speed. In the stationary X-Y frame, this results in sinusoidal force components along the X and Y axes. The Laplace transform of the residual force vector produced by this imbalance fault is:

$$Δ A ( s ) = me {ω}^{2} ( \begin{matrix}\frac{s}{{s}^{2} + {ω}^{2}} \\ \frac{s}{{s}^{2} + {ω}^{2}} \\ 0 \\ 0\end{matrix} ) ,$$

where ΔF(s) is the mathematical model representing residual forces induced by the particular fault. For instance, this is referenced at procedure 520 of flow diagram 500.

Mechanical system 100 is modeled as a linear time invariant (LTI) dynamical system. For a disc 160 of mass m_{d}, the relationship between external forces and translational-rotational acceleration at sensor 140 can be represented in the Laplace domain by the transfer function matrix:

$$[ H ( s ) ] = ( \begin{matrix}A ( s ) & 0 \\ 0 & B ( s )\end{matrix} ) ,$$

$$where ,$$

$$A ( s ) = ( \begin{matrix}\frac{1}{{m}_{d} {s}^{2}} & 0 \\ 0 & \frac{1}{{m}_{d} {s}^{2}}\end{matrix} ) .$$

Thus, H(s) maps generalized forces acting on disc 160 to generalized accelerations at the sensor location. For instance, this corresponds to procedure 530 of flow diagram 500.

Using the transfer function H(s), the residual vibration (i.e., fault-induced acceleration) is:

$${\ddot{q}}_{r e s} ( t ) = {ℒ}^{- 1} \{ [ H ( s ) ] Δ F ( s ) \} ,$$

where [symbol] is the inverse Laplace operator. Substituting the expressions for [H(s)] and ΔF(s) above:

$${\ddot{q}}_{res} ( t ) = {ℒ}^{- 1} \{ \frac{me {ω}^{2}}{{m}_{d}} ( \begin{matrix}\frac{s}{{s}^{2} + {ω}^{2}} \\ \frac{s}{{s}^{2} + {ω}^{2}} \\ 0 \\ 0\end{matrix} ) \} = \frac{me {ω}^{2}}{{m}_{d}} ( \begin{matrix}cos ( ω t ) \\ sin ( ω t ) \\ 0 \\ 0\end{matrix} ) .$$

Thus, the imbalance fault introduces a narrowband sinusoidal residual vibration at the rotational frequency ω, with amplitude scaled by the ratio me/m_{d}, where this is the synthesized residual vibration data. For instance, this corresponds to procedure 540 of flow diagram 500.

Since the accelerometer sensor measures only translational vibration, the observable residual vibration along the X-Y-Z axes simplifies to:

$${\ddot{q}}_{res , obs} ( t ) = \frac{m e {ω}^{2}}{{m}_{d}} ( \begin{matrix}cos ( ω t ) \\ sin ( ω t ) \\ 0\end{matrix} ) .$$

To generate synthetic fault vibration data for an imbalance fault, the residual vibration is superimposed on the measured healthy vibration data:

$${\ddot{q}}_{F} ( t ) = {\ddot{q}}_{H} ( t ) + {\ddot{q}}_{res , obs} ( t ) = {\ddot{q}}_{H} ( t ) + \frac{m e {ω}^{2}}{{m}_{d}} ( \begin{matrix}cos ( ω t ) \\ sin ( ω t ) \\ 0\end{matrix} ) .$$

For instance, this corresponds to procedure 550 of flow diagram 500.

In a specific example, assume:
disc mass m_{d}=10 kg,
unbalanced mass m=0.1 kg,
eccentricity e=0.01 m,
rotational speed ω=2π·50 rad/s (50 Hz).
   Then the peak residual acceleration along X at the sensor is:

$$\frac{m e {ω}^{2}}{{m}_{d}} = \frac{0.1 \times 0.01 \times {( 2 π \cdot 50 )}^{2}}{10} \approx 9.87 m / {s}^{2} ,$$

thus, the synthesized imbalance component at the sensor is approximately:

$${\ddot{q}}_{res , X} ( t ) \approx 9.87 cos ( 2 π \cdot 50 t ) m / {s}^{2} ,$$

which is added to the measured healthy acceleration \ddot{q}_{H,X}(t) to obtain the synthetic fault vibration data \ddot{q}_{F,X}(t).

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

1. A method for synthesizing fault data in a mechanical system, the method comprising:
collecting vibration data from a mechanical system during operation, wherein the vibration data is collected at at least one sensor coupled to the mechanical system;
synthesizing residual vibration data using a mathematical model representing residual forces induced by a particular fault of the mechanical system; and
combining the vibration data with the synthesized residual vibration data to generate fault vibration data for the particular fault, wherein the fault vibration data simulates data associated with an unobserved event.

2. The method of claim 1, further comprising:
training a proxy machine learning model using the fault vibration data to perform fault detection on the mechanical system to identify the particular fault during operation of the mechanical system.

3. The method of claim 2, further comprising:
deploying the proxy machine learning model to perform the fault detection on the mechanical system on the collected vibration data.

4. The method of claim 1, further comprising:
deriving the mathematical model representing the residual forces induced by the particular fault of the mechanical system.

5. The method of claim 4, further comprising:
using a Linear Time Invariant (LTI) model of the mechanical system, calculating a transfer function from the residual forces to the residual vibration data.

6. The method of claim 1, wherein the mechanical system is modeled as linear time invariant behavior.

7. The method of claim 1, wherein the mechanical system is a rotational system.

8. The method of claim 7, wherein the mechanical system comprises a rotor bearing.

9. The method of claim 1, wherein the collected vibration data is time series sensor data.

10. The method of claim 1, wherein the mathematical model is a dynamical model comprising a plurality of tunable parameters, wherein the plurality of tunable parameters are used to model the particular fault.

11. A system for synthesizing fault data in a mechanical system, the system comprising:
a sensor coupled to the mechanical system, the sensor for sensing vibration data from the mechanical system during operation;
a data acquisition module for collecting the vibration data from the mechanical system during operation; and
a computational module configured to:
synthesize residual vibration data using a mathematical model representing residual forces induced by a particular fault of the mechanical system; and
combine the vibration data with the synthesized residual vibration data to generate fault vibration data for the particular fault, wherein the fault vibration data simulates data associated with an unobserved event.

12. The system of claim 11, wherein the computational module is further configured to:
train a proxy machine learning model using the fault vibration data to perform fault detection on the mechanical system to identify the particular fault during operation of the mechanical system.

13. The system of claim 12, further comprising:
a fault detection module comprising the proxy machine learning model to perform the fault detection on the mechanical system on the collected vibration data.

14. The system of claim 11, wherein the computational module is further configured to:
derive the mathematical model representing the residual forces induced by the particular fault of the mechanical system.

15. The system of claim 14, wherein the computational module is further configured to:
use a Linear Time Invariant (LTI) model of the mechanical system to calculate a transfer function from the residual forces to the residual vibration data.

16. The system of claim 11, wherein the mechanical system is modeled as linear time invariant behavior.

17. The system of claim 11, wherein the mechanical system is a rotational system.

18. The system of claim 17, wherein the mechanical system comprises a rotor bearing.

19. The system of claim 11, wherein the collected vibration data is time series sensor data.

20. The system of claim 11, wherein the mathematical model is a dynamical model comprising a plurality of tunable parameters, wherein the plurality of tunable parameters are used to model the particular fault.
